(19) United States
(12) Patent Application Publication
(10) Pub. No.: US 2025/0088825 A1
(43) Pub. Date: Mar. 13, 2025

(54) PRIVACY-PRESERVING TECHNIQUES FOR LOCATING CONTACTS

(71) Applicant: Apple Inc., Cupertino, CA (US)

(72) Inventors: Siva Ganesh Movva, San Jose, CA (US); Katherine K. Ernst, San Francisco, CA (US); Kerry Nguyen, Huntington Beach, CA (US); Michael C. Laster, Santa Clara, CA (US); Alexander R. Hanuska, Campbell, CA (US)

(73) Assignee: Apple Inc., Cupertino, CA (US)

(21) Appl. No.: 18/797,162

(22) Filed: Aug. 7, 2024

Related U.S. Application Data
(60) Provisional application No. 63/537,794, filed on Sep. 11, 2023.

(51) Int. Cl. H04W 4/029; H04L 9/32; H04W 4/02; H04W 60/00

(52) U.S. Cl. CPC H04W 4/029; H04L 9/3213; H04W 4/023; H04L 2209/80; H04W 60/00

(57) ABSTRACT

The present application relates to devices and components, including apparatus, systems, and methods for enabling privacy-preserving techniques for discovering the precise location of a device by another device using short range positioning schemes.

### CROSS-REFERENCES TO OTHER APPLICATIONS

This application claims priority to U.S. Provisional Application No. 63/537,794, for “PRIVACY-PRESERVING TECHNIQUES FOR LOCATING CONTACTS” filed on Sep. 11, 2023, which is herein incorporated by reference in its entirety for all purposes.

### TECHNICAL FIELD

This application generally relates to technologies for locating and finding devices, in particular, privacy-preserving technologies for finding a device's location with high precision.

### BACKGROUND

There are a number of applications available that allow users to locate their contacts or friends. These applications use a global positioning system (GPS) to track the location of the user's phone and display it on a map. Some of these applications also allow users to share their location with others so that they can see where they are at all times.

The use of these applications can be beneficial. For example, they can be used to keep track of children or elderly relatives or to coordinate with friends or family members during a trip. They can also be used for safety purposes, such as in an emergency. They can also raise some privacy concerns. Some people may be uncomfortable with the idea of others being able to track their location. Furthermore, these applications may become less effective when the user and the device are not collocated.

### BRIEF SUMMARY

A mobile device, a findee device, may be configured to be discoverable. The configuration may make the device discoverable by a specific finder device. The finder device may use its connections to the findee device to find the findee device with high precision.

The user of the findee device, the findee, may be associated with multiple devices. For example, the findee may have a watch paired with a phone. According to various embodiments, a device that is more representative of the location of the findee may become the findee device without the finder's (or finder device's) knowledge of the devices associated with the findee, hence preserving the privacy of the findee.

The findee may make itself discoverable to more than one finder. According to various embodiments, a unique token may be associated with a finding session that includes a findee device associated with the findee and a finder device associated with the finder. The token allows the findee to control its discoverability, e.g., cancel or temporarily pause it, without impacting the discoverability by other finders.

The findee device may be online, e.g., connected to a network, or offline, e.g., turned off or not connected to any network. According to some embodiments, the findee device may be discoverable regardless of whether it is online or offline.

These and other embodiments of the disclosure are described in detail below. For example, other embodiments are directed to systems, devices, and computer-readable media associated with methods described herein.

A better understanding of the nature and advantages of embodiments of the present disclosure may be gained with reference to the following detailed description and the accompanying drawings.

### BRIEF DESCRIPTION OF THE DRAWINGS

The following description includes discussion of figures having illustrations given by way of examples of implementations. The drawings should be understood by way of example and not by way of limitation. As used herein, references to one or more examples are to be understood as describing a particular feature, structure, or characteristic included in at least one implementation of the invention. Phrases such as “in one example” or “in an alternative example” appear herein to provide examples of implementations of the invention and do not necessarily all refer to the same implementation. However, they are also not necessarily mutually exclusive.

FIG. 1 illustrates a system environment in accordance with some embodiments.

FIG. 2 illustrates an example implementation of a finding session in accordance with some embodiments.

FIG. 3 illustrates an example implementation of finding functionality in accordance with some embodiments.

FIG. 4 illustrates an example of a symmetric token generation signaling in accordance with some embodiments.

FIG. 5 illustrates examples of token rotation in accordance with some embodiments.

FIG. 6 illustrates examples of findee device selection in accordance with some embodiments.

FIG. 7 illustrates a method for implementing finder management in accordance with some embodiments.

FIG. 8 illustrates a signaling diagram in accordance with some embodiments.

FIG. 9 illustrates a signaling diagram in accordance with some embodiments.

FIG. 10 illustrates a method for implementing privacy preserving finding in accordance with some embodiments.

FIG. 11 illustrates a method for implementing privacy preserving finding in accordance with some embodiments.

FIG. 12 illustrates a method for implementing privacy preserving finding in accordance with some embodiments.

FIG. 13 is a block diagram of an example device according to the embodiments of the present disclosure.

### DETAILED DESCRIPTION

A user may have one or more devices that are associated with the user. The devices may be subscribed to common services. For example, the user may use an Apple ID or a Google account to access services and sign in to devices or applications. Some services may be provided by a service or application server. For example, the server may provide storage services or music or video streaming services. The server may provide services through which users can locate their devices or share their location with others.

The user may configure a device to be discoverable by other devices associated with the user. The device may register its location with the server, and other devices may access the device coordinates on the server and identify the device's location using an application such as a map application. The device may update or register its location with the server periodically.

The user may share a device's location with another person, e.g., a friend. The device may send its location information, e.g., GPS coordinates, to the server. The location information may be updated periodically. The location information may be associated with the user's subscription account and may only be accessed by the user's authorized devices or authorized users or subscribers.

In an example, the user sharing their location can be User A, and the authorized user allowed to access the location information can be User B. User B may open an application on a device that allows them to retrieve the location information of User A. User B may send a request to retrieve User A's location, the User B's device may send a request to the server. The server may authenticate the request, retrieve the location data associated with User A, and send it back to the requesting device. The requesting device may display the location on a map. The server may send a notification to User A indicating that User B is retrieving their location information.

User A may have multiple devices associated with the same subscriber account on the server. For the purpose of location sharing, the user may identify one of the devices associated with the location-sharing application. The identified device may be referred to as the me-device. The other users with whom User A shares their location may retrieve the location of the me-device.

Once the authorized User B identifies User A's location, User B may determine that User A is nearby. User B's device may use ranging and positioning techniques that utilize network and Internet connection or peer-to-peer communication channel (P2P, also referred to as device-to-device or D2D) to find User A's device's precise location.

### I. OVERVIEW

Herein, the “finding” or “discovery” refers to a process in which one device finds the location of another device with high precision, at least in part through ranging or other techniques that use a P2P communication channel between two devices. Finding is a distinct process from location sharing in which a device obtains the location information of another device from a server.

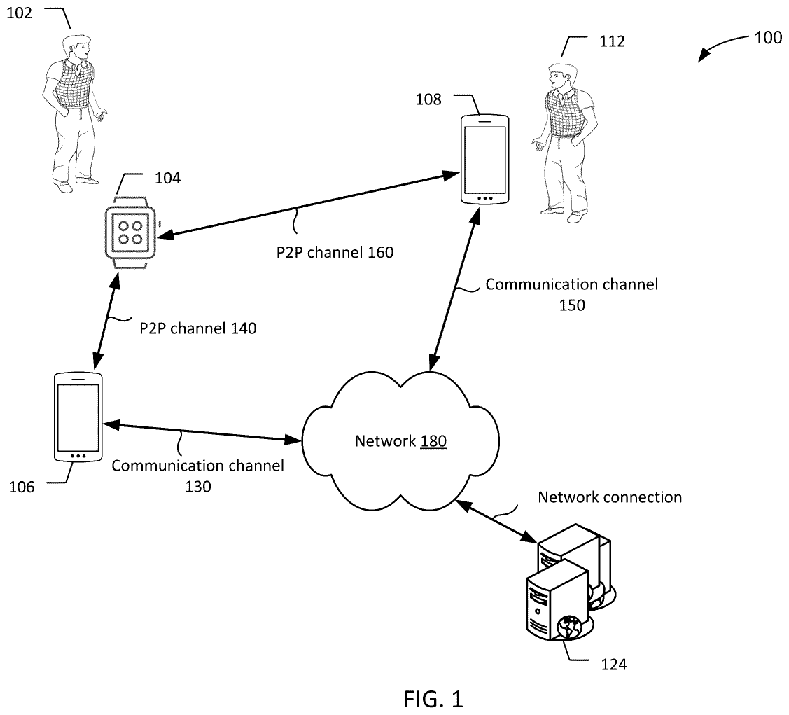

FIG. 1 illustrates a system environment 100 in accordance with some embodiments. The system environment 100 may include device 104. Device 104 may be communicatively coupled with device 106 via P2P channel 140. The P2P channel 140 may be a short-range wireless technology such as Bluetooth®, WiFi, NFC, or cellular. Devices 104 and 106 may be associated with user 102. Device 104 may be a smartwatch. Device 106 may be a smartphone.

Device 106 may be communicatively connected to network 180 via communication channel 130. The air interface of communication channel 130 may be provided by cellular technology, such as fifth- or sixth-generation wireless, or by wide area networks (WAN) or local area networks (LAN), such as WiFi. Devices 104 and 106 may be communicatively coupled with server 124 through network 180.

Server 124 may provide services such as storage services, application store, music or video streaming services, or financial services such as online payment. Server 124 may provide a secure and private channel for handling and delivery of messages and notifications between devices. Server 124 may securely transmit data between devices. The resources associated with the server 124, e.g., storage, computation, memory, or connectivity, may be distributed in different geographic locations.

User 102 may be subscribed to services on server 124. User 102 subscription may be associated with an identification (ID). The ID may be associated with the user's personal information, such as their name, email address, or payment information. When user 102 sets up a device, they may use the ID to register the device on server 124 and to associate it with the user's account, which may allow user 102 to access their personal data and use services provided by server 124 on the device, e.g., devices 104 or 106. The server 124 may identify a user with their ID or information associated with their devices, e.g., a phone number. The information associated with a user may be maintained in a user profile on server 124.

User 102 may be associated with user 112. User 112 may not have a subscription or ID with server 124. User 112 may be associated with device 108. Device 108 may be communicatively coupled with network 180 via communication channel 150. Communication channel 150 may use similar technologies as described above for communication channel 130.

User 102 may choose to share the device 104 location (or device 106 location) with the user 112. User 112 may use an application on device 108 that allows them to retrieve the location information associated with user 102. The application may send a request to the server 124 to retrieve the location information. Server 124 may use cryptography techniques to securely send the location information associated with user 102 to the application on device 108.

Server 124 may use public-private key cryptography to encrypt the location information of user 102. For example, the server may use the public key associated with user 112 or device 108 to encrypt the location information, and device 108 may use the private key to decrypt the location information.

Different from location sharing described above, user 102 may make their device 104 findable by user 112, e.g., authorizing device 108 associated with user 112 to discover the location of device 104 with high precision.

Based on the location information, device 108 or the application used to retrieve the location information of user 102 or user 112 may determine that they are in proximity to the location shared by device 104. The location may be the location of the device 104 and, by association, an indication of the location of user 102. When device 104 has made itself findable by device 108, and device 108 is in close range of device 104, devices 108 and 104 may collaborate via P2P channel 160 or connections via LAN or WAN or through network 180 to assist user 112 using device 108 to precisely find the location of device 104. User 102 may be referred to as the findee user, device 104 may be referred to as the findee device, user 112 may be referred to as the finder user, and device 108 may be referred to as the finder device. The P2P channel 160 may be provided by ultra-wideband (UWB), Bluetooth®, WiFi, or other short-range communication technologies.

While location sharing allows the finder user to identify the whereabouts of the findee device, the finding procedure, when device 104 makes itself findable or discoverable by device 108, would allow user 102 to precisely identify the location of device 104. For example, by location sharing, device 108 may identify that device 104 is inside a building, and if device 104 made itself findable by device 108, device 108 may find the exact location of device 104 with high precision.

### II. FINDING PROCEDURE

Through some mechanisms, e.g., location sharing, the finder may determine that the findee is nearby and activate the discovery or finding functionality. In some instances, the finder may activate the discovery or finding functionality without being in the vicinity of the findee or findee device. The finder user may activate the finding functionality by selecting or choosing the finding option on an application running on the finder's device.

### A. Token-Based Identification

A token may be associated with a findee and a finder user as a unique identifier used for enabling short-range positioning through a P2P channel. A findee user may choose, e.g., by selecting an option on an application running on a device associated with the findee user, to authorize or permit the finder user to find the findee's location with high precision, at least in part based on a P2P connection. The findee user may authorize the finder user for a period of time. A unique token may be associated with a finding session.

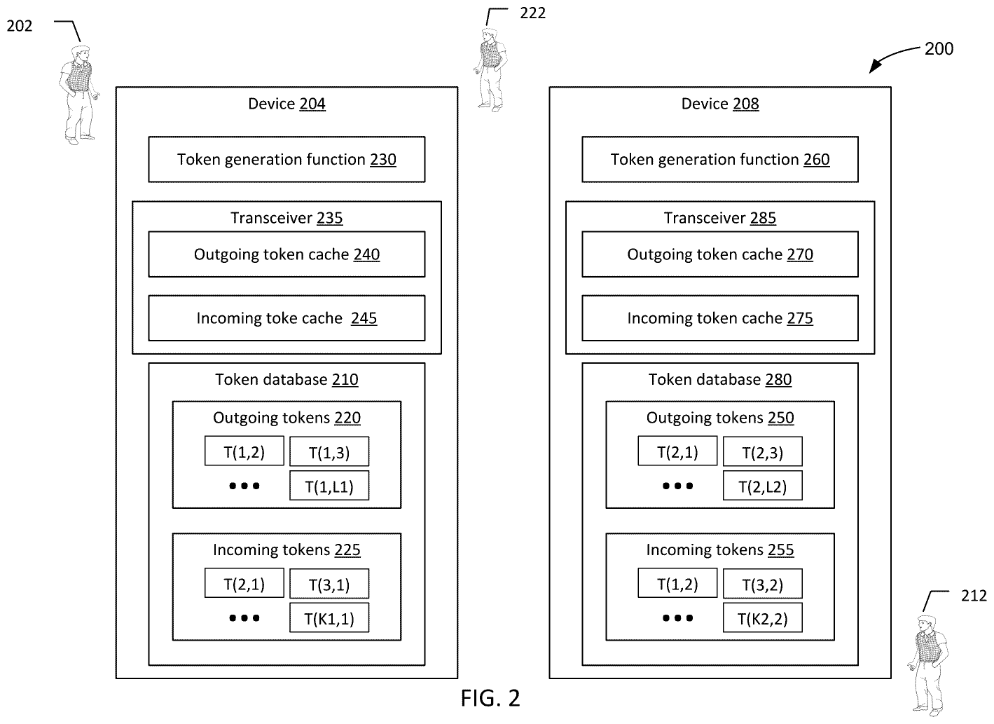

FIG. 2 illustrates an example implementation of finding session 200 in accordance with some embodiments. Device 204 may be an example of device 104 in FIG. 1, and device 208 may be an example of device 108 in FIG. 1.

Consider users 202, 212, and 212. Let user 202 be identified with index 1, user 212 with index 2, and user 222 be identified with index 3. When user 202 makes themselves discoverable to user 212 by authorizing user 212 to find user 202, users 202 and 212 obtain a token, T(1,2), associated with the finding session. The first index in T(1,2), i.e., 1, indicates the user index of the findee, and the second index in T(1,2), i.e., 2, indicates the user index of the finder device. Therefore, for example, T(1,2) is the token associated with a finding session in which the user with index 1, user 202, is the findee user, and the user with index 2, user 212, is the finder.

The findee user may store the token in the outgoing token storage of the token database. Some parts or the entire token database may be stored on the findee device. The finder user may store the token in the token database's incoming token storage. Some parts or the entire token database may be stored on the finder device. For example, token T(1,2) may be stored in the outgoing token 220 of token database 210 on device 204 associated with user 202. Similarly, token T(1,2) may be stored on the incoming tokens 255 of token database 280 on device 208 associated with user 212.

Similarly, user 212 may authorize user 202 to find their location. Users 212 and 202 may obtain token T(2,1) indicating that the user index 2, user 212, is the findee user, and user index 1, user 202, is the finder. Token (2,1) may be stored in the incoming token 225 of token database 210 on device 204 associated with user 202. Token T(2,1) may be stored on the outgoing token 250 of token database 280 on device 208 associated with user 212.

User 202 may authorize user 222 to find their location with high precision and associated token T(1,3) to the corresponding finding session. User 202 may authorize L1 users to find its location and may receive authorization to find the location of K1 many users. Similarly, user 212 may receive authorization from L2 many users to find their locations and may receive authorization from K2 many users.

A device may store part or all the tokens in a cache memory allocated on a module that can be powered and used even if the device is in sleep mode or offline, e.g., not connected to a network. For example, device 204 may cache some of the tokens in outgoing token cache 240 or incoming token cache 245. Similarly, device 208 may cache some of the tokens in outgoing token cache 270 or incoming token cache 275. The cache memory may be part of the transceiver circuitry. In one example, the outgoing token cache 240 and incoming token cache 245 may be part of the transceiver 235 of device 204. Similarly, the outgoing token cache 270 and incoming token cache 275 of device 208 may be part of the transceiver 285. For example, outgoing or incoming token cache memory may be part of the communication chip, e.g., Bluetooth chip or UWB chip.

In some embodiment, when user 202 authorized user 212 to find their location with high precision, at least in part using the P2P, users 202 and 212 may obtain token T(1,2) associated with the finding session by independently generating token T(1,2) on their respective devices. For example, user 202 may generate token T(1,2) using token generation function 230 on device 204, and user 212 may generate token T(1,2) using token generation function 260 on device 208. The tokens generated on both devices have the same value and are associated with the same finding session.

### B. Token-Based Finding Process

Once the token is generated by the findee and finder devices, the finder may use it to find a findee device. Through some mechanisms, e.g., location sharing, the finder may determine that the findee is nearby and activate the discovery or finding functionality. The finder user may activate the finding functionality by selecting or choosing the finding option on an application running on the finder's device.

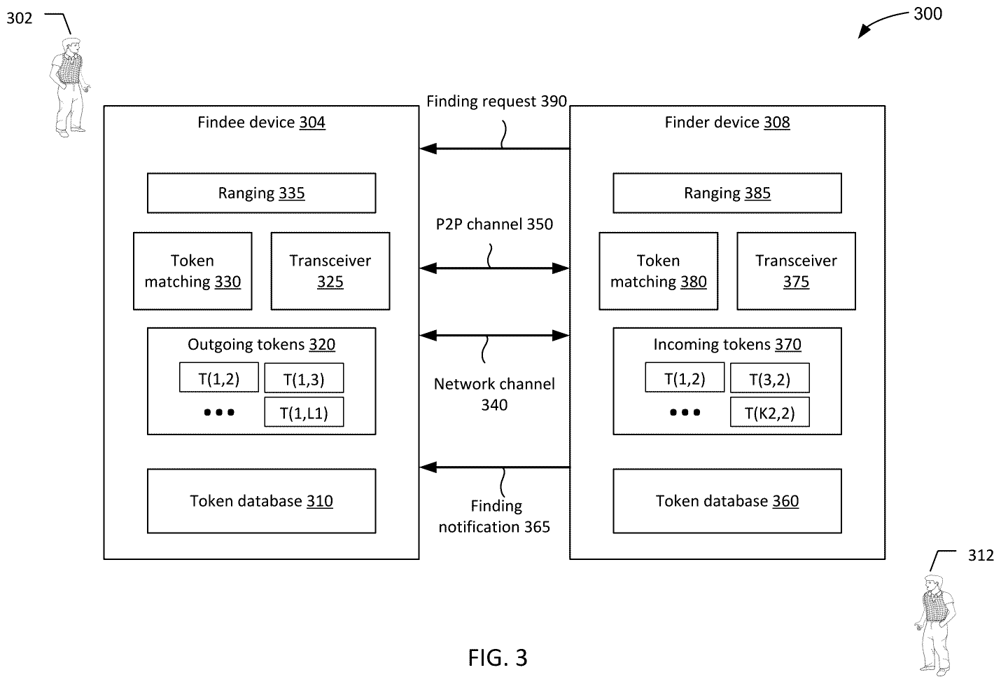

FIG. 3 illustrates an example implementation of finding functionality 300 in accordance with some embodiments. Device 304 may be an example of device 104 in FIG. 1, and device 308 may be an example of device 108 in FIG. 1.

When finder user 312 chooses, e.g., on an application running on finder device 308, to find the findee device 304, the application through device 308 may send a finding request message to the server. The server, based on the finding request, may send a finding notification to findee device 304. Finding notification may indicate that the finder user 312 has requested or initiated a finding procedure to find the location of the findee user 302 by locating the findee device 304 with high precision. The notification may inform user 302 and allow them to permanently or temporarily make themselves undiscoverable by finder user 312 and their associated devices, e.g., finder device 308. When finder device 308 or findee device 304 are offline, discovery may be made over the local or P2P links, e.g., Bluetooth or WiFi. The findee user may not need to respond to the notification. The transceiver associated with the local network or P2P may scan for the findable tokens.

In another example, when finder user 312 chooses, e.g., on an application running on finder device 308, to find findee device 304, the application through device 308 may send a finding notification message 365 directly to findee device 304. Finder device 308 may include the token in the finding request message. Findee device 304 may or may not respond to the finding notification message 365 from finder device 308. For example, findee user 302 may be determined to be unfindable by finder 312 and, based on such determination, not reply to the finding request message from finder device 308. Finder device 308 may send the finding request message on a P2P channel.

In some embodiments, the findee device 304 may determine a token associated with a finding session based on the finding notification 365. The findee device 304 may broadcast the identified token. For example, the findee device 304 may receive a notification indicating that finder user 312 has initiated or requested to find user 302. The findee device may identify token T(1,2) in the outgoing token 320 associated with the finding session in which user 302 is the findee and user 312 is the finder. Findee device 304 may broadcast token T(1,2) on transceiver 325. Transceiver 325 may, at least in part, use the P2P channel 350 or the radio and technologies associated with the P2P channel 350. In addition to P2P channel 350, the transceiver 325 may use other available radio resources, e.g., network channel 340, for broadcasting the token T(1,2).

In some instances, finder device 308 may broadcast advertisement messages, including a token associated with the findee device 304. The findee device monitors the received advertisement messages for a matched token. Once the findee device 304 detects a match, it may respond to the finder's advertisement message. The reception of the advertisement and matching may be performed on the transceiver circuitry. The transceiver circuitry may be referred to as antenna-on-package (AoP).

Finder device 308 may receive the broadcasted token T(1,2) on transceiver 375. Finder device 308 may use token matching function 380 to determine that the token is associated with a finding request. Finder device 308 may retrieve the token associated with the finding request from the incoming token 370.

Using the token, devices 304 and 308 may identify the corresponding signals from one another and may use ranging functions 335 or 385 to reveal the location of device 304 to device 308 with high precision.

In some instances, when findee device 304 broadcasts the token T(1,2), the P2P channel between findee device 304 and finder device 308 may not be established. In some instances, when findee device 304 broadcasts the token T(1,2), the P2P channel between findee device 304 and finder device 308 may be established. In the instance that the P2P channel between findee device 304 and finder device 308 is established, the finder device 308 may not identify device 304 as the findee device before receiving the token T(1,2).

In some instances, the advertisement packet may include an address and an authentication tag. The advertisement may rotate every M minutes, e.g., every 15 minutes. The shared secret may be used to generate discovery tokens, which may contain the identity resolving key (IRK) for the rotating advertisements.

In some instances, broadcasting a token may involve including a value associated with the token in the broadcasted message. For example, T(1,2) may be a 32-bit binary number, and the broadcast message may include a field of length 32 bits that takes the value of a 32-bit binary number representing T(1,2). Similarly, token matching functions 330 or 380 may match the value of the token received by the transceiver 325 or 375 with the value of the token. For example, transceiver 325 may send the value of the token T(1,2) in a broadcast message. Transceiver 375 may receive the broadcast message, extract the value of the token from the message, and pass it to the token matching 380, and token matching 380 may compare the received value of the token with those stored in the database.

In some instances, broadcasting a token may involve encrypting a broadcast message using a token. For example, using symmetric cryptography techniques, findee device 304 may encrypt a broadcast message using token T(1,2) and send the message using transceiver 325. Finder device 308 may receive the broadcasted encrypted message on transceiver 375. The token matching may involve attempting to decrypt the received message using a token, and a token would match if the token could be used to decrypt the received message.

In one example, the finding application on the findee device or a nearby interaction functionality on the findee device may inform the transceiver, e.g., the Bluetooth chip, of a list of tokens to be monitored. The transceiver may scan or monitor tokens in the received advertisement packets for a match with its own list of tokens.

In another example, the transceiver circuitry, e.g., the Bluetooth chip, at the finder may receive tokens that are selected by the finder use on an active user interface, e.g., the user selecting a findee on the app and initiating ranging.

Outgoing tokens 320 may be part of token database 310 or maybe a separate cache memory that retrieves some or all of the tokens from the database. Device 304 may only include a token stored in the outgoing tokens 320 in a broadcast message. When findee device 304 receives a finding notification, it may retrieve the associated token from the token database 310 and temporarily store it in the outgoing tokens 320.

Similarly, incoming tokens 370 may be a separate cache memory that retrieves some or all of the tokens from the database. Finder device 308 may only match a received token against the tokens stored in the incoming tokens 370. When finder device 308 sends the finding request 390, it may retrieve the associated token from the token database 360 and temporarily store it in the incoming tokens 370.

In some embodiments, the finder device 308 may broadcast the token associated with the finding session of findee device 304. For example, once finder device 308 determines that findee device 304 is nearby, finder device 308 may use transceiver 375 to broadcast the token T(1,2). Transceiver 375 may, at least in part, use P2P channel 350 or the radio and technologies associated with P2P channel 350. In addition, transceiver 375 may use other available radio resources, e.g., network channel 340, for broadcasting the token T(1,2).

Findee device 304 may receive the broadcast token T(1,2) on transceiver 325. Findee device 304 may use token matching function 330 to determine that the token is associated with finding notification. Findee device 304 may retrieve the token associated with the finding notification from outgoing tokens 320.

In some instances, when finder device 308 broadcasts the token T(1,2), the P2P channel between findee device 304 and finder device 308 may not be established. In some instances, when findee device 304 broadcasts the token T(1,2), the P2P channel between findee device 304 and finder device 308 may be established. In the instance that the P2P channel between findee device 304 and finder device 308 is established, the finder device 308 may not identify device 304 as the findee device before receiving the token T(1,2). P2P channel establishment may entail discovery, pairing, authentication, and data exchange. Transmission on a P2P channel hereby may refer, in part, to sending broadcast signals on the frequency band supported by the P2P technology and reception of broadcasted signals by devices that can receive and decode the broadcasted signals.

### III. PRIVACY PRESERVING

There might be multiple devices associated with a findee user, and maybe only one of them accurately represents the location of the findee user. For example, the findee user may be inside a house with a phone and a watch, leaving the phone inside and the findee with their watch on in the backyard. Assuming that the findee's me-device associated with the location sharing is the phone. The finder may find the house based on the phone's location. However, to find the precise location of the findee, the finder may need to find the precise location of all the devices that might be associated with the findee. It is desired that the finder be able to find the precise location of the device associated with the findee user's location without being required to find all devices associated with the findee, thus preserving the privacy of the findee.

In some embodiments, a token is introduced to preserve the findee's privacy. The token may uniquely be associated with the finding procedure or finding session where the findee authorizes the finder to find the findee's precise location. The finder device is authorized to discover a findee's device associated with a token known to both findee's device and the finder's device.

In different examples, the following features may be performed separately or together. The tokens can be regenerated in a synchronized manner to reduce the likelihood of discovering a token by eavesdropping devices or malicious devices.

The devices associated with the findee can determine which device may best represent the location of the findee user and assign the token to that device.

The findee may manage the finders. The finder device may temporarily or permanently revoke the authorization granted to the finder devices.

### A. Unique Token Generation

Each finding session may involve a findee and a finder and may have a unique token associated with it. The unique token allows the findee to manage each finding session independently of other finding sessions.

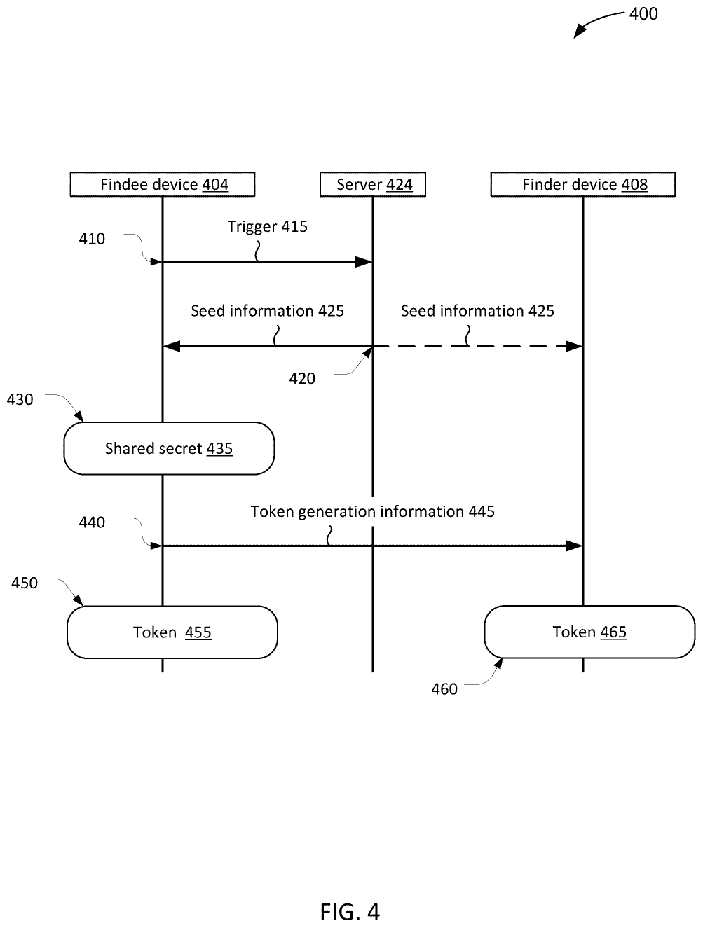

FIG. 4 illustrates an example of a symmetric token generation signaling 400 in accordance with some embodiments. Device 404 may be an example of device 104 in FIG. 1, device 408 may be an example of device 108 in FIG. 1, and server 424 may be an example of server 124 in FIG. 1.

At 410, findee 404 may initiate a finding session and send a trigger 415 associated with the finding session to server 424. For example, the findee user may choose, on an application running on device 404, to authorize the finder to find the location of the findee with high precision. Trigger 415 may be a message sent by the findee device 404 to the server 424. The message may include an identification of the finder user or an indication of authorization associated with the finder user.

At 420, based on the finding session trigger 415 sent by the findee device 404, server 424 may generate seed information 425. Seed information 425 may be a timestamp, referred to as the base date. The base date may be an arbitrary date randomly chosen. The base date may be the timestamp when the trigger was received at server 424. Seed information 425 may be a randomly generated number or information that the findee and finder user had previously agreed upon, e.g., a phrase or a password.

In some instances, server 424 may send seed information 425 only to findee device 404. Findee device 404 may forward the seed information to finder device 408. In some instances, server 424 may send seed information 425 to both findee device 404 and finder device 408.

At 430, findee device 404 may generate shared secret 435. For example, shared secret 435 may be a randomly generated bit string. The length of the shared secret may be, but not limited to, 2, 4, or 6 bytes. In one example, the shared secret may be randomly generated 32-byte data. The shared secret may be generated each time the findee shares its location with the finder. For example, if the findee stops sharing the location and then shares its location again, a new shared secret is generated. In one example, the findee may use the base date to generate the shared secret. In another example, the findee may not use the base date to generate the shared secret.

At 440, findee device 404 may send token generation information 445 to finder device 408. Token generation information 445 may include seed information 425 or shared secrete 435. Findee device 404 may send token generation information 445 to finder device 408 through a secure channel provided by server 424. The token generation message may be encrypted, e.g., using public key encryption schemes.

At 450, the findee device 404 may generate token 455 associated with the finding session. Findee device 404 may generate token 455 before sending token generation information 445 to finder device 408 at 440.

In one example, the base date is used to generate a token. For example, the base date may be used to determine an identifier. The identifier may be used as an input into a cryptography method, e.g., a key derivation function, to derive an encryption key or token. For example, the identifier may be used in a hash-based message authentication code (HMAC)-based key derivation function (HKDF) to derive a symmetrical key. In one example, all or a subset of bytes in the key may be used to generate the discovery or finding token. In one example, the first B bytes, e.g., B=16, of the key may be used to generate the discovery token.

At 460, finder device 408 may generate token 465 associated with the finding session based on the token generation information 445. Tokens 455 and 465 may have the same value.

### B. Token Rotation and Synchronization

The findee and finder devices may include tokens in broadcast messages, which other devices may receive. It is desired or beneficial to change the tokens regularly to reduce the likelihood of unauthorized users obtaining and using tokens. On the one hand, it is desirable for the findee and finder to update their token at the same time. On the other hand, the finder and findee may not agree on the time because they are in different time zones and because users may deliberately or accidentally change the time on their devices. In one example, a centralized transmission of a token renewal message to all devices having a token can cause findee and finder devices to update their tokens upon receiving the token renewal message.

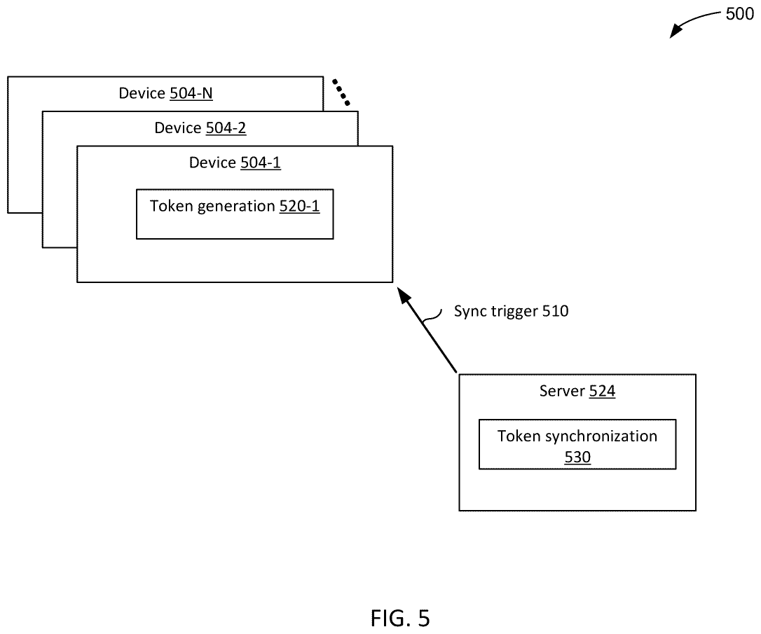

FIG. 5 illustrates examples of token rotation 500 in accordance with some embodiments. Token rotation 500 may include a token synchronization function 530 at server 524. Server 524 may send a sync trigger message 510 to all devices with tokens, e.g., devices 504-1, 504-2, . . . , 504-N, collectively denoted by device 504. Each device 504 may include a token generation function. For example, device 504-1 may include token generation function 520-1. Once devices 504 receive sync trigger message 510, they may generate and update the tokens in their token database, including updating incoming and outgoing tokens.

The sync trigger message 510 may enable the findee and finder devices associated with a finding session to simultaneously and synchronously update their tokens associated with the finding session.

In one instance, the finder and findee devices may generate multiple tokens when initiating the finding session. When the finder and findee devices receive sync trigger message 510, they may simultaneously discard the current token and select the next token.

Synchronization trigger 510 may provide a universal periodicity to update the tokens throughout the system.

Server 524 may be an example of server 124 in FIG. 1, and device 504 may be an example of device 104 or device 108 in FIG. 1. The server may include a schedule for sending the synchronization trigger 510. The schedule may include an initial date, e.g., Jan. 1, 1990. The server may send a synchronization trigger 510 once every D day from the initial date. An example value for D may be but is not limited to, 3 days, 5 days, or 7 days. For example, if the value of D is 7 days and the initial date is Jan. 1, 1990, the server would send a synchronization trigger message 510 on Jan. 8, 1990, Jan. 15, 1990, and so on. Consider that the server sends a synchronization trigger message 510 once every 7 days. A finder and findee that establish a token-based friendship 3 days after the last synchronization trigger message 510 may receive a synchronization trigger message 510 after 4 days of generating the token and may regenerate a new token.

In one example, token rotation is performed on the device. Both finder and findee devices have a shared secret and the base date. The may generate new tokens based on the shared secret and based date as described above. The device may use the based date to obtain an identifier. For example, the identifier may indicate the number of elapsed D-day cycles between the initial date and the current date. For example, in the example above, the identifier on Jan. 1, 1990, may be 0, and the identifier on Jan. 8, 1990, may be 1. The identifier may be used as input for the key derivation function used to generate the token.

### C. Findee Device Selection

A findee user may have multiple devices, e.g., a smartphone and a smartwatch. The location of one of the devices may be most accurately representative of the location of the findee user. For example, a smartphone that is detected to be moving, with high probability, is being carried by the user. Therefore, it is desired that the smartphone be the findee device. However, if the smartphone is detected to be stationary and unpaired from the watch, and the watch is detected to be on the wrist, it is likely that the watch is with the findee. In this scenario, it is desired that the watch be the findee.

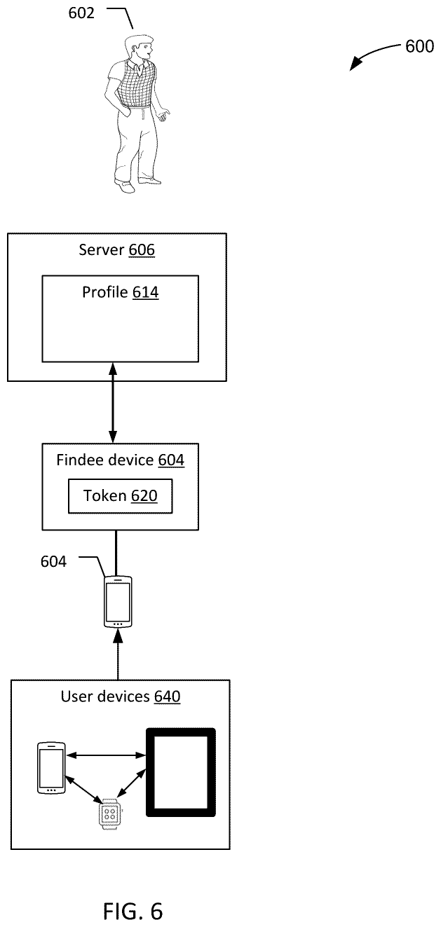

FIG. 6 illustrates examples of findee device selection 600 in accordance with some embodiments. Findee user 602 may be associated with profile 614 in server 606. The profile 614 may include an indication of the findee device 604 associated with user 602. The server may use the indication to send a synchronization trigger message to the findee device 604. The findee device may include token 620 associated with a finding session.

User devices 640 may include more than one device. At a given time, one or more of device 640 may be more closely representative of the location of user 602. For example, a phone that is detected to be moving is likely to be with user 602. In another example, a smartwatch that is not paired with a phone and is detected to be on the wrist of user 602 may more accurately represent the location of user 602.

One or more devices of user devices 640 may be configured with a set of rules, such as those described above, to determine a device to be findee device 604. Only findee device 604 may broadcast token 620 or respond to signals or messages from a finder device. For example, a phone may be configured to decide which device to be the findee device 604 and configure it.

In one example, the findee device may determine a condition that indicates that the findee device may no longer be the findee device or may indicate that another device is the new findee device. Upon determining the condition, the findee device may disable being a findee device, which may include not responding to any requests from a finder device. In one example, the disabling of being a findee may include removing data or configurations associated with being a findee device. In one example, a disable findee device may receive synchronization messages from the server and may update its tokens or not update its tokens. In one example, a disabled findee device may not receive synchronization messages from the server.

In one example, a watch may become a findable device when it is disconnected from the phone, i.e., out of Bluetooth range, and is on the wrist. Watch may send a message over the secured server to tell the phone to stop being the findable device.

Findee device 604 may be an example of findee device 104 in FIG. 1.

### D. Finder Management

Although the findee might authorize the finder to find the findee's location, there might be conditions that the findee may desire not to be findable by the finder. It is desired that the findee be able to enable or disable their findability without permanently revoking the authorization from the finder.

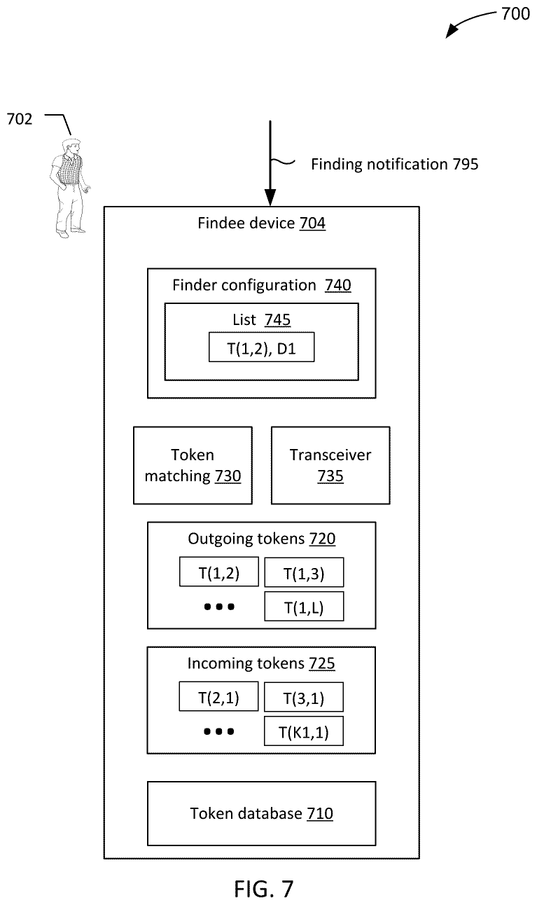

FIG. 7 illustrates a method for implementing finder management 700 in accordance with some embodiments. Findee device 704 may be an example of findee device 104 in FIG. 1. Findee device 704 may include a finder configuration 740 functions. In one embodiment, finder configuration 740 may include a list 745 of incoming or outgoing tokens. The finder configuration 740 may include privacy configuration that may prevent findee device 704 from broadcasting tokens or responding to messages containing a token if the token is in the list 745. In another implementation, a token may be permanently or temporarily removed from outgoing tokens 720 or incoming tokens 725 cache memories. A token removed from the outgoing tokens 720 or incoming tokens 720 cache memories may still remain in token database 710.

User 702, or an application, may add a token associated with finding sessions or a finder user to list 745. For example, when user 702 receives notification 795 of a finder initiating a finding procedure to discover the location of user 702, user 702 may choose to be unfindable to the finder. Findee 702 may also choose a duration for the remaining unfindable to the finder. Findee 702 choices may be added to list 745. For example, token T(1,2) associated with a finding session in which user index 2 is the finder, along with a duration D1, may be added to list 745. Findee device 704 may ignore all incoming messages, including token T(1,2), or may not transmit any message, including token T(1,2), for the duration of D1.

In one example, findability may depend on location services and location-sharing settings or configurations. A device may be findable based on the configuration of location-sharing settings and location services.

For example, the findee device may use token matching function 730 to compare a received token on the transceiver 735 with tokens in list 745 or tokens in the incoming tokens 725. Once a received token is matched with a token in list 745, the associated configuration may apply. Similarly, once a received token is matched with a token in outgoing tokens 720 or incoming token 725, the findee device may apply the associated configuration or response.

In another example, findee device 704 may detect a device setting, e.g., a do-not-disturb setting. Based on the detected setting, findee device 704 may ignore responding or stop the broadcast of one or more tokens from incoming tokens 725 or outgoing tokens 720.

Having a unique token associated with a finder user allows the findee user to manage finders and to temporarily make themselves unfindable by a finder user.

### IV. EXAMPLE PROCEDURES

### A. Finding Session Procedure

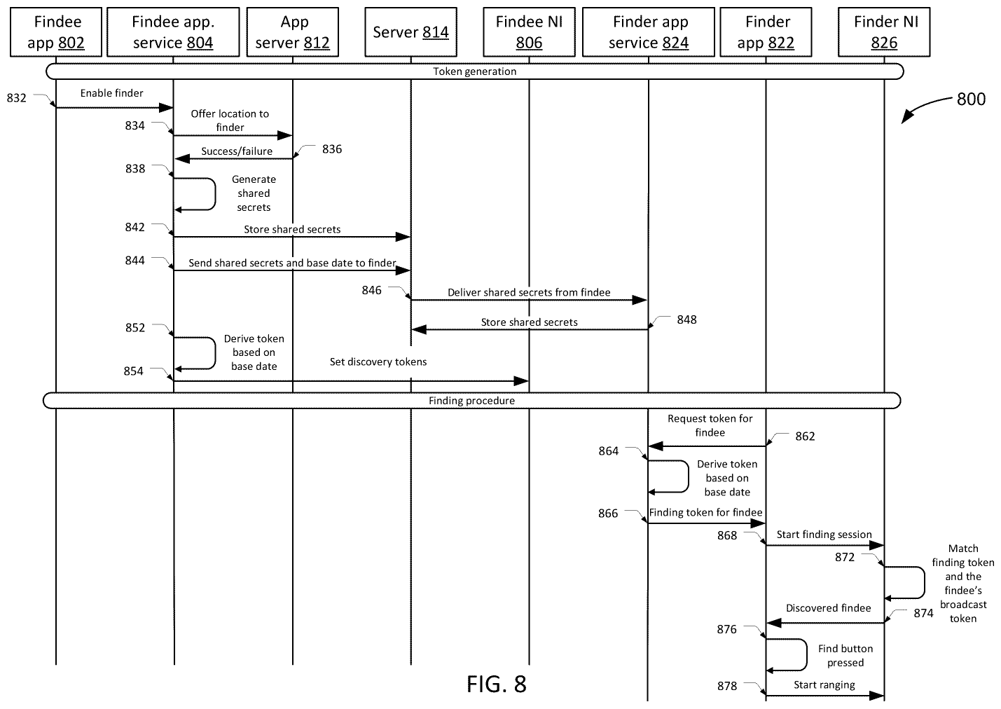

FIG. 8 illustrates a signaling diagram 800 in accordance with some embodiments. Signaling diagram 800 may be an example of signaling used to implement token generation or finding sessions.

The signaling diagram 800 may include messages to or from a findee application 802. Findee application 802 may provide the user interface and an interface to interact with findee application service 804. Findee application service 804 may be the system service or software on the findee device responsible for findee location, generation of cryptography for findee shared secret, distributing the secret between devices and generating tokens and synchronization among devices, trigger ranging through the server 814, showing notification on the findee device and sending periodic configuration updates throughout the ranging session including location and additional information or configurations.

Similarly, signaling diagram 800 may include messages to or from a finder application 822 or finder application service 824. Finder application 822 may have similar functionality as findee application 802. Finder application service 824 may have similar functionality as findee application service 804.

The signaling diagram 800 may include messages to or from different servers. Application server 812 may be responsible for creating, hosting, or running the application, facilitating communication, managing resources, providing security, reducing client complexity, storing or caching data associated with the application, or controlling data flow associated with the application. Server 814 may include one or more servers. For example, Server 814 may include a server associated with the findee or a server associated with the finder. Server 814 may be responsible for creating and managing user's data, providing access to services, storing user data, or managing configurations associated with the security and privacy of the user.

Signaling diagram 800 may include messages to or from a findee nearby interaction (NI) 806. Findee NI 806 may be responsible for range measurement and configuration data generation. Similarly, signaling diagram 800 may include messages to or from a finder NI 826. Finder NI 826 may have the same functionality as findee NI 806.

### 1. Friendship Establishment, Token Generation

At 832, the findee enables the finder to find the findee's location. Findee application 802 may send an indication to findee application service 804. The indication may include identification information of the finder and an indication that the findee authorizes or permits the finder to find the findee's location with high accuracy using a combination of P2P or network links. The indication may include a time duration associated with the authorization.

At 834, findee application service 804 may send a message to application server 812 indicating that the findee device is offering or authorizing the finder to find the findee's location based on ranging through a P2P link.

At 836, the application server 812 may send a message to the findee application service indicating whether the offer or authorization was granted to the finder successfully. The message may include a base time. The base time may be a timestamp associated with the time at which the application server 812 received the message sent at 834, e.g., the message indicating an offer or authorization for the finder to find the findee's location. The timestamp at the application server 812 may be based on the local or internal clock of the application server 812.

At 838, the findee application service 804 may generate shared secrets. The shared secret may be an input parameter to a key derivation function that may produce one or more keys or tokens. The tokens may be used to encrypt or authenticate messages exchanged between finder and findee devices.

At 842, the findee application service 804 may send a message to server 814 to store the shared secrets. The message may include the shared secret or an indication of the findee, e.g., the findee ID or an ID associated with the findee's device.

At 844, findee application service 804 may send a message to the finder device through server 814 that includes the shared secrets and the base date. This message may be encrypted by the findee device. Server 814 may provide a secure end-to-end encrypted communication channel between the findee and finder. The server on which the shared secrets are stored at 842 may be different from the server on which the messages to finder are sent at 844. For example, the server used to store the shared secret at 842 may be a cloud storage server, and the server used for secure communication at 844 may be a dedicated server for providing authentication, identification, and secure and private communication links among users.

At 846, server 814 may send a message to finder application service 824 and deliver the shared secrets. The message may also include the base date. Server 814 may forward the message it received from the findee device at 844 to the finder device.

At 848, finder application service 824 may send a message to server 814 to save the shared secrets. Server 814 may include one or more servers. The server associated with the finder device may not be the same server associated with the findee device. The server or cloud storage at which the finder stores the shared secrets may not be the same server or cloud storage at which the findee stored its shared secrets.

At 852, findee application service 804 may derive the tokens based on base date and shared secrets. The findee may broadcast the token in a beacon that may be discovered by the finder. The token may be referred to as a discovery token. The generated token may be referred to as an outgoing token, and it may be used in a finding session with the finder device. The token is unique to the finder-findee pair. The findee may generate a different token for a finding session associated with a different finder (or finder device). Finder application service 824 may similarly derive a corresponding token based on base date and shared secrets. The finder token and findee token may have the same value. The token at the finder may be referred to as an incoming token.

At 854, findee application service 804 may set the discovery tokens at findee NI 806. For example, findee NI 806 may include a transceiver module that includes hardware and software components that could store and use discovery tokens. In one instance, the tokens may be stored in memory in a communication chip or integrated circuit, e.g., Bluetooth or UWB chips.

### 2. Finding Procedure

Once the finder identified that a findee device was nearby, the finder may initiate a finding session to find the location of the findee based on the P2P link and associated ranging techniques.

At 862, finder application 822 may send a request message to finder application service 824 to obtain the token associated with the findee. An updated token may be available and stored on server 814 or on the finder device. In another example, the token may be required to regenerated.

At 864, finder application service 824 may retrieve the token or regenerate the token based on the shared secret and the base date. Finder application service 824 may store the shared secret locally or may retrieve it from server 814.

At 866, finder application service 824 sends a message to finder application 822, where the message may include the token associated with the findee device.

At 868, finder application 822 may send a message to finder NI 826 and trigger or start a finding session.

At 872, finder NI 826 may compare the local token associated with the findee device and the associated finding session with a token received from the findee device. The finder device may receive the token from the findee device in a broadcast message.

At 874, upon detecting a match between the local token associated with the finding session and the findee and the token received in a broadcast message from the findee, finder Ni 826 may send a message to finder application 822. The message may include an indication that the findee has been discovered.

At 876, the user interface of finder application 822 may indicate to the finder that the findee device (and, implicitly, the findee user) is discoverable. The finder user may push the “find” button on the user interface of finder application 822.

At 878, finder application 822, in response to the “find” button being pushed, may send a message to finder NI 826 to start the ranging procedure.

### B. Triggering Ranging Session Procedures

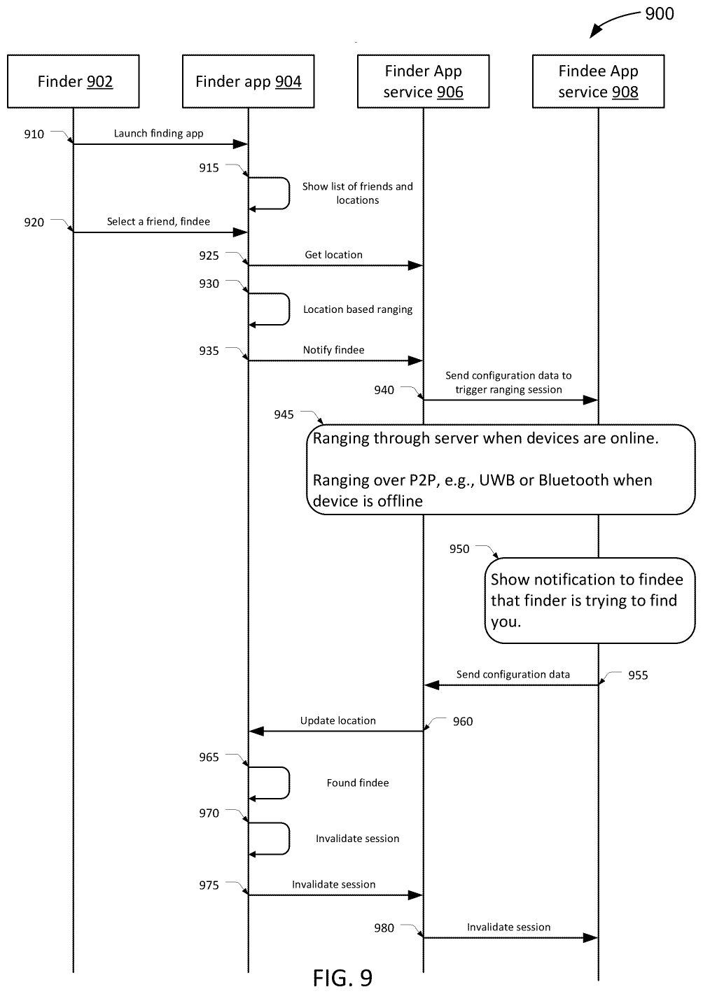

FIG. 9 illustrates a signaling diagram 900 in accordance with some embodiments. Signaling diagram 900 may be an example of signaling used for triggering ranging and notifying users.

At 910, finder user 902 may launch finder application 904. The operating system (OS) may initiate and configure finder application 904.

At 915, the user interface of finder application 904 may indicate to user 902 a list of friends and their locations. For example, finder application 904 may display the location of friends, contacts, or potential findee users on a map on the screen of the finder device. Finder user 902 may determine that a findee user is nearby.

At 920, based on determining that a findee user is nearby, finder user 902 may select the nearby findee. For example, finder user 902 may select an icon associated with the findee user on the screen. Finder application 904 may be informed of the selection of the findee.

At 925, finder application 904 may send a request to finder application service 906 to obtain the location of the findee.

At 930, finder application 904 may trigger the performance of locating the findee based on ranging techniques and technologies. The finder NI may perform locating the findee.

At 935, finder application 904 may send a message to finder application service 906. The message may include a request to notify the findee regarding the finder's interest in finding its location through ranging techniques.

At 940, finder application service 906 may send configuration data to findee application service 908 to trigger a ranging session. The configuration data may include local address, e.g., device identifier, security features associated with a ranging session, and the initiator or responder configurations. The parameters in configuration data may be communicated between devices using a secure out-of-band mechanism such as Bluetooth Low Energy (BLE).

At 945, finder application service 906 and findee application service 908 may perform ranging through server or P2P link when devices are online or over P2P link when devices are offline.

At 950, the user interface of the findee device may show a notification to the fine user that the finder user is trying to find them.

At 955, findee application service 908 may send configuration data associated with the findee device to finder application service 906.

At 960, upon completion of ranging and obtaining the location of the findee device, finder application service 906 may send a message to finder application 904. The message may include the location information of the findee device. Finder application 904 may use the location information to update the location associated with the findee.

At 965, finder application 904 may indicate to the finder user that the findee is found and provide the location information.

At 970, finder application 904 may invalidate or terminate the finding session.

At 975, finder application 904 may send a message to finder application service 906 indicating that the finding session is terminated.

At 980, finder application service 906 may send a message to finder application service 908 indicating that the finding session is terminated.

### C. Finder Procedures

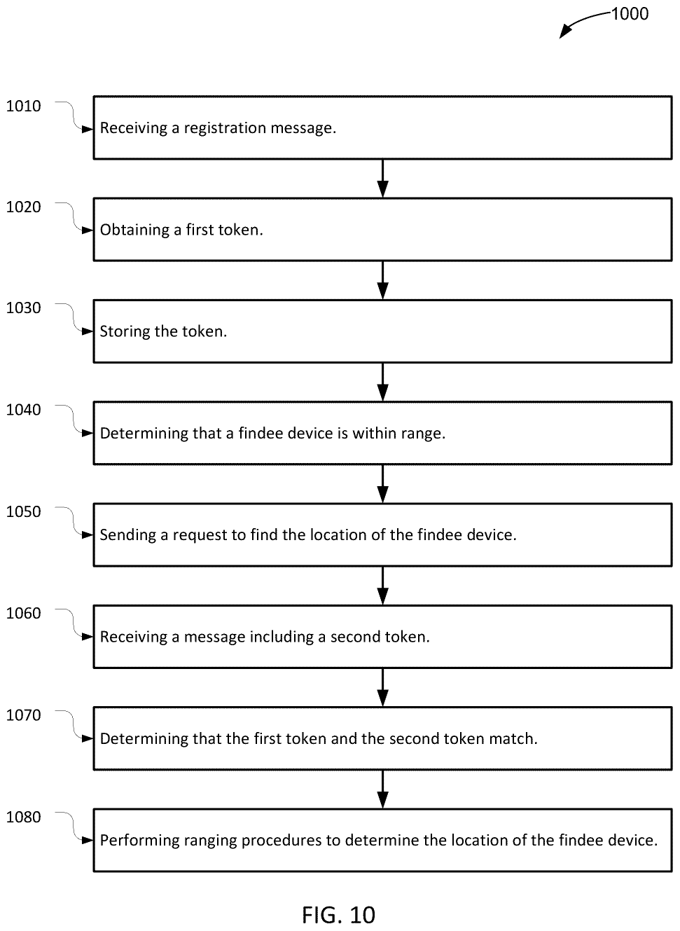

FIG. 10 illustrates a method for implementing privacy preserving finding 1000 in accordance with some embodiments. Privacy-preserving finding 1000 is an example of a procedure implemented by a finder device, e.g., findee device 108, in accordance with some embodiments.

At 1010, the method may include receiving a registration message from the findee device. The registration message may include information that indicates the findee device has registered to share future location data with the finder device. The findee device may register with an application and service server.

At 1020, the method may include obtaining a first token based on the information in the registration message. The token is associated with the findee device and the finder device. The finder device may generate the token based on the information in the registration message. The finder device may use a base date and shared secret information included in the information in the registration message to generate the token.

At 1030, the method may include storing the token for future use. The finder may store the token in a token database. The finder device may store the token in a cache memory. For example, the finder device may store the token in a cache memory in a transceiver chip.

At 1040, the method may include determining that the findee device is within range. The finder device may receive the location information of the findee device from a location-sharing application. The finder device may obtain its own location based on GPS information of the current location of the finder device. The finder device may estimate the distance between the finder device and the findee device. The finder device may determine that the findee device is within range when the distance between the finder device and the findee device is within a threshold distance.

The finder may use location-sharing information or a P2P link to determine the ranging capability of the findee. In one example, when the finder determines that the findee has ranging capability, the finder may initiate a ranging procedure. For example, the finder may use Bluetooth or UWB connection or ranging establishment signaling to determine whether the findee has ranging capability. In one example, the finder may include the token associated with the finding session in the Bluetooth or UWB connection or ranging establishment signaling, and the findee initiates the ranging procedure in response to receiving the connection or ranging establishment signaling and matching the token with a finding session.

At 1050, the method may include sending a request to find the location of the findee device to the findee device. Based on the determination that the findee device is within range, the finder user may choose, e.g., on or via a finding application, to find the location of the findee device with high precision, e.g., by using positioning signaling and techniques. In one example, the finding request may be sent to the server from the finding application in response to the finder user choosing to find the findee.

At 1060, the method may include receiving a message, including a second token. The message may be sent by the findee device. The message may be sent on a local communication channel, e.g., a P2P channel. The P2P channel may be provided by technologies such as Bluetooth®, WiFi, or UWB.

At 1070, the method may include determining that the second token matches the first token. The finder device authenticates that the second token is associated with the finding session between the findee and finder devices.

At 1080, the method may include performing ranging procedures to determine the location of the findee device. The ranging procedure may include the transmission of ranging reference signals by the findee or finder devices, receiving the ranging reference signals by the findee or finder devices, performing measurements on the received reference signals, and estimating the location based on the measurements. The ranging procedure may include the findee device sending more precise location information to the finder device. The location information may be absolute or relative location information.

### D. Finder Procedures

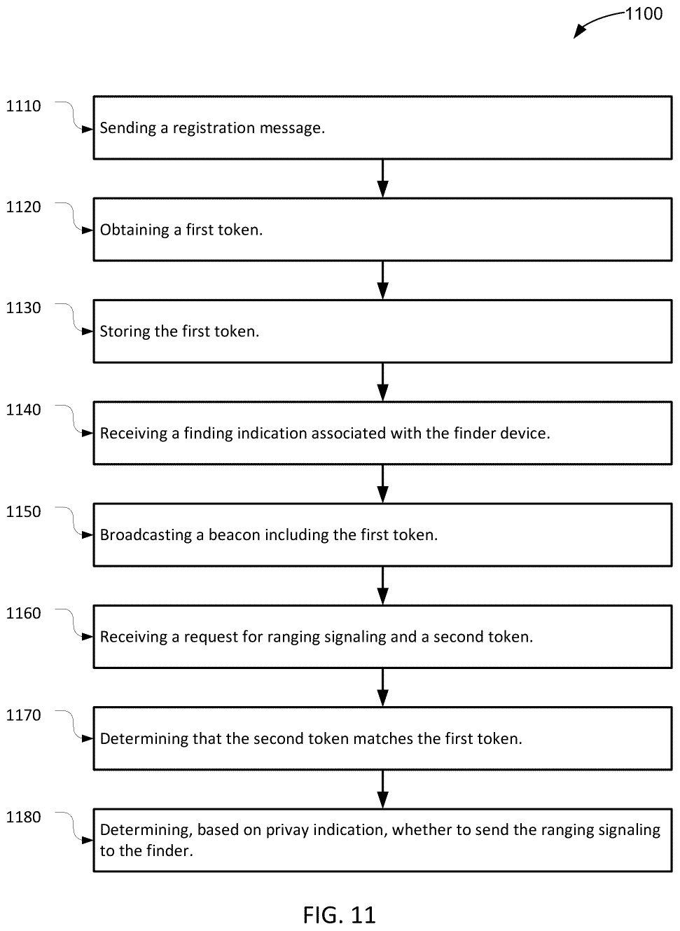

FIG. 11 illustrates a method for implementing privacy preserving finding 1100 in accordance with some embodiments. Privacy-preserving finding 1100 is an example of a procedure implemented by a finder device, e.g., finder device 104, in accordance with some embodiments.

At 1110, the method may include sending a registration message to the finder device. The registration message may include information that indicates the findee device has registered to share future location data with the finder device. The findee may send a message to the server indicating authorizing the finder to find the findee device. The findee may receive a based date from the server. The findee may generate a shared secret. The shared secret may be a sequence of binary digits that are randomly generated. The information sent to the finder device may include the shared secret and the base date.

At 1120, the method may include obtaining a first token based on the information in the registration message. The token is associated with the findee device and the finder device. The findee device may generate the token based on the information in the registration message. The finder device may use the base date and the shared secret information included in the information in the registration message to generate the token.

At 1130, the method may include storing the token for future use. The findee may store the token in a token database. The findee device may store the token in a cache memory. For example, the finder device may store the token in a cache memory in a transceiver chip.

At 1140, the method may include receiving a finding indication associated with the finder device. The finding indication may be a notification sent by the server to the findee. For example, when the finder initiates finding the findee, the finder may send a finding request to the server. The server, in response to the finding request from the finder device, may send a finding indication to the findee. The findee may receive the indication if the findee device is connected to the server, e.g., the findee device is online (or in an online state) or connected to the network.

At 1150, the method may include broadcasting a beacon, including the first token. If the findee device is in an online state, it may initiate broadcasting the beacon in response to receiving the finding indication. The findee device selects the token that is associated with the finder device associated with the finding indication. If the findee device is in an offline state, it may broadcast the beacon periodically in response to entering an offline state.

At 1160, the method may include receiving a message, including a request for transmission of ranging signaling and a second token. The message may be sent by the finder device. The message may be sent on a local communication channel, e.g., a P2P channel. The P2P channel may be provided by technologies such as Bluetooth®, WiFi, or UWB.

At 1170, the method may include determining that the second token matches the first token. The finder device authenticates that the second token is associated with the finding session between the findee and finder devices.

At 1180, the method may include determining whether to respond to the finder device's request for transmission of ranging signaling. The findee may make the determination based on privacy indication. The privacy indication may be associated with the findability of the findee user. For example, the privacy indication may indicate whether the findee user may make itself discoverable or findable by the finder device. If a privacy indication indicates that the findee is hiding its location from the finder, then the findee may ignore the request from the finder. If there is not privacy indication associated with the finder, or if the privacy indication does not indicate hiding the location of the findee from the finder, or if the privacy indication does indicate revealing the location of the findee to the finder, then the findee may transmit ranging signaling to the finder device.

The privacy indication may be associated with a time duration. For example, the findee device may configure its privacy settings to prevent it from being findable by one or more finders for a given period of time, e.g., an hour or a day. Findee devices may be able to assign a different privacy duration to different finders.

### E. Server Procedures

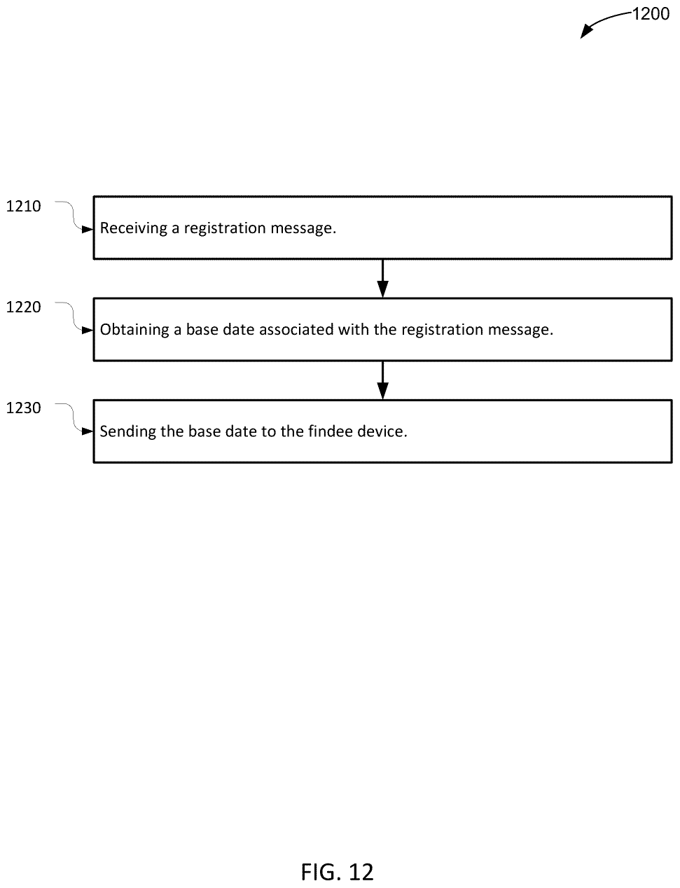

FIG. 12 illustrates a method for implementing privacy preserving finding 1200 in accordance with some embodiments. Privacy-preserving finding 1200 is an example of a procedure implemented by a server, e.g., server 124, in accordance with some embodiments.

At 1210, the method may include receiving a registration message from the findee device. The registration message may indicate the findee device's desire to share its location data with a finder device.

At 1220, the method may include obtaining a base date associated with the registration message. The base date may be the time that the server received the registration message. The base date may be randomly generated bits that do not represent any date.

At 1230, the method may include sending the base date to the findee device.

In addition, the server may maintain a synchronization schedule. Based on the synchronization schedule, the server may send synchronization triggers to devices that are registered to or connected with the server. Upon receiving the synchronization trigger, the device may regenerate its tokens and replace the old tokens with newly generated ones. The server may receive a cancelation message from the findee or the finder device to terminate a finding session associated with the findee and the finder devices.

### V. EXAMPLE DEVICE

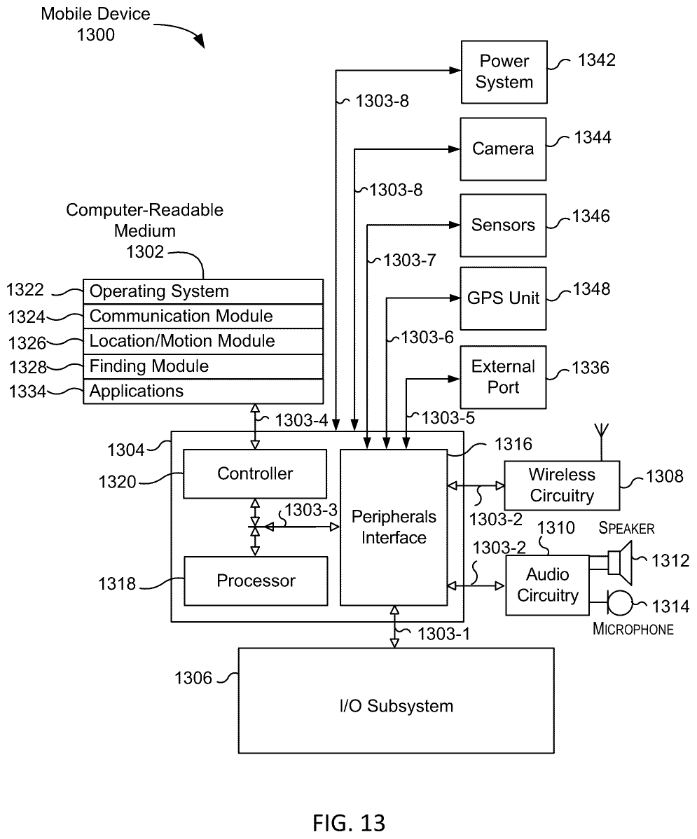

FIG. 13 is a block diagram of an example device according to the embodiments of the present disclosure. Device 1300 generally includes computer-readable medium 1302, a processing system 1304, an Input/Output (I/O) subsystem 1306, wireless circuitry 1308, and audio circuitry 1310, including speaker 1312 and microphone 1314. These components may be coupled by one or more communication buses or signal lines 1303. Device 1300 can be any portable electronic device, including a handheld computer, a tablet computer, a mobile phone, a laptop computer, a tablet device, a media player, a personal digital assistant (PDA), a key fob, a car key, an access card, a multi-function device, a mobile phone, a portable gaming device, a headset, or the like, including a combination of two or more of these items.

It should be apparent that the architecture shown in FIG. 13 is only one example of an architecture for device 1300 and that device 1300 can have more or fewer components than shown or a different configuration of components. The various components shown in FIG. 13 can be implemented in hardware, software, or a combination of both hardware and software, including one or more signal processing and/or application-specific integrated circuits.

Wireless circuitry 1308 is used to send and receive information over a wireless channel or network to one or more other devices conventional circuitry such as an antenna system, an RF transceiver, one or more amplifiers, a tuner, one or more oscillators, a digital signal processor, a CODEC chipset, memory, etc. Wireless circuitry 1308 can use various protocols, e.g., as described herein. In various embodiments, wireless circuitry 1308 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WiFi (such as IEEE 802.11a, IEEE 802.11b, IEEE 802.11g and/or IEEE 802.11n), Bluetooth, Wi-MAX, voice over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1308 is coupled to processing system 1304 via peripherals interface 1316. Peripherals interface 1316 can include conventional components for establishing and maintaining communication between peripherals and processing system 1304. Voice and data information received by wireless circuitry 1308 (e.g., in speech recognition or voice command applications) is sent to one or more processors 1318 via peripherals interface 1316. One or more processors 1318 are configurable to process various data formats for one or more application programs 1334 stored on medium 1302.

Peripherals interface 1316 couples the input and output peripherals of device 1300 to one or more processors 1318 and computer-readable medium 1302. One or more processors 1318 communicate with computer-readable medium 1302 via a controller 1320. Computer-readable medium 1302 can be any device or medium that can store code and/or data for use by one or more processors 1318. Computer-readable medium 1302 can include a memory hierarchy, including cache, main memory, and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks), and DVDs (digital video discs). In some embodiments, peripherals interface 1316, one or more processors 1318, and controller 1320 can be implemented on a single chip, such as processing system 1304. In some other embodiments, they can be implemented on separate chips.

Processor(s) 1318 can include hardware and/or software elements that perform one or more processing functions, such as mathematical operations, logical operations, data manipulation operations, data transfer operations, controlling the reception of user input, controlling output of information to users, or the like. Processor(s) 1318 can be embodied as one or more hardware processors, microprocessors, microcontrollers, field programmable gate arrays (FPGAs), application-specified integrated circuits (ASICs), or the like.

Device 1300 also includes a power system 1342 for powering the various hardware components. Power system 1342 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management, and distribution of power in mobile devices.

In some embodiments, device 1300 includes a camera 1344. In some embodiments, device 1300 includes sensors 1346. Sensors can include accelerometers, compass, gyrometer, pressure sensors, audio sensors, light sensors, barometers, and the like. Sensors 1346 can be used to sense location aspects, such as auditory or light signatures of a location.

In some embodiments, device 1300 can include a GPS receiver, sometimes referred to as a GPS unit 1348. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1318 run various software components stored in medium 1302 to perform various functions for device 1300. In some embodiments, the software components include an operating system 1322, a communication module 1324 (or set of instructions), a location module 1326 (or set of instructions), a geofence module 1328 that is used as part of geofence monitoring operation described herein, and other application programs 1334 (or set of instructions).

Operating system 1322 can be any suitable operating system, including iOS, Mac OS, Darwin, RTXC, LINUX, UNIX, OS X, WINDOWS, or an embedded operating system such as Vx Works. The operating system can include various procedures, sets of instructions, software components and/or drivers for controlling and managing general system tasks (e.g., memory management, storage device control, power management, etc.) and facilitates communication between various hardware and software components.

Communication module 1324 facilitates communication with other devices over one or more external ports 1336 or via wireless circuitry 1308 and includes various software components for handling data received from wireless circuitry 1308 and/or external port 1336. External port 1336 (e.g., USB, FireWire, Lightning connector, 60-pin connector, etc.) is adapted for coupling directly to other devices or indirectly over a network (e.g., the Internet, wireless LAN, etc.).

Location/motion module 1326 can assist in determining the current position (e.g., coordinates or other geographic location identifiers) and motion of device 1300. Modern positioning systems include satellite based positioning systems, such as Global Positioning System (GPS), cellular network positioning based on “cell IDs,” and WiFi positioning technology based on a WiFi networks. GPS also relies on the visibility of multiple satellites to determine a position estimate, which may not be visible (or have weak signals) indoors or in “urban canyons.” In some embodiments, location/motion module 1326 receives data from GPS unit 1348 and analyzes the signals to determine the current position of the mobile device. In some embodiments, location/motion module 1326 can determine a current location using WiFi or cellular location technology. For example, the location of the mobile device can be estimated using knowledge of nearby cell sites and/or WiFi access points with knowledge also of their locations. Information identifying the WiFi or cellular transmitter is received at wireless circuitry 1308 and is passed to location/motion module 1326. In some embodiments, the location module receives the one or more transmitter IDs. In some embodiments, a sequence of transmitter IDs can be compared with a reference database (e.g., Cell ID database, WiFi reference database) that maps or correlates the transmitter IDs to position coordinates of corresponding transmitters, and computes estimated position coordinates for device 1300 based on the position coordinates of the corresponding transmitters. Regardless of the specific location technology used, location/motion module 1326 receives information from which a location fix can be derived, interprets that information, and returns location information, such as geographic coordinates, latitude/longitude, or other location fix data.

Finding module 1328 may perform functions and procedures associated with creating and maintaining finding sessions, as well as signaling associated with finding procedures consistent with embodiments described herein.

The one or more applications 1334 on device 1300 can include any applications installed on the device 1300, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1306 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1306 can include a display and user input devices such as a keyboard, mouse, and/or trackpad. In some embodiments, I/O subsystem 1306 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1302) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1306 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1300 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

For the purposes of the present document, the phrase “A or B” means (A), (B), or (A and B), and the phrase “based on A” means “based at least in part on A,” for example, it could be “based solely on A,” or it could be “based in part on A.”

What is claimed is:

1. A method implemented by a finder device, the method comprising:
receiving, from a findee device, a registration message including information that indicates the findee device has registered to share future location data with the finder device;
obtaining, based on the information in the registration message, a first token associated with the findee device and the finder device;
storing the first token for future use;
determining, by the finder device, that the findee device is within a threshold distance of the finder device;
sending, to the findee device, a request to find a location of the findee device, based on the determination, by the finder device, that the findee device is within the threshold distance of the finder device;
receiving, from the findee device via a local communication channel, a message including a second token;
determining that the second token matches the first token; and
performing, based on determining that the second token matches the first token, ranging procedures to determine the location of the findee device.

2. The method of claim 1, wherein the obtaining the first token associated with the findee device comprises:
generating the first token based on the information in the registration message.

3. The method of claim 1, wherein the information in the registration message includes a base date and a shared secret.

4. The method of claim 1, wherein the first token is configured to enable a finder user of the finder device to determine the future location data of a findee user of the findee device.

5. The method of claim 1, the method further comprising;
receiving, from a server, a synchronization trigger message;
obtaining, based on the synchronization trigger message and the information in the registration message, a third token associated with the findee device and the finder device; and
replacing the first token with the third token.

6. A findee device, comprising:
one or more memories; and
one or more processors in communication with the one or more memories and configured to execute instructions stored in the one or more memories to perform operations comprising:
sending, to a finder device, a registration message including information that indicates the findee device has registered to share future location data with the finder device;
obtaining, based on the information in the registration message, a first token associated with the findee device and the finder device;
storing the first token for future use;
receiving a finding indication associated with the finder device;
sending, based on the finding indication, a beacon including the first token associated with the findee device and the finder device;
receiving, from the finder device a request for a transmission of ranging signaling and a second token;
determining that the second token matches the first token; and
determining, based on a privacy indication, whether to send to the finder device, ranging signaling based on the determination that the second token matches the first token.

7. The findee device of claim 6, wherein the first token is configured to enable a finder user of the finder device to determine the future location data of a findee user of the findee device.

8. The findee device of claim 6, wherein the obtaining the first token associated with the findee device and the finder device comprises:
generating the first token from the information in the registration message.

9. The findee device of claim 6, wherein the operations further comprises;
receiving, from a server, a base date; and
generating a shared secret, wherein the information in the registration message includes the base date and the shared secret.

10. The findee device of claim 9, wherein the obtaining the first token associated with the findee device and the finder device comprises:
generating the first token from the information in the registration message.

11. The findee device of claim 6, wherein the privacy indication is associated with hiding from the finder device; and the determining, based on the privacy indication, whether to send to the finder device, ranging signaling based on the determination that the second token matches the first token includes:
determining, based on the privacy indication, not to send to the finder device, ranging signaling based on the determination that the second token matches the first token.

12. The findee device of claim 6, wherein the privacy indication is associated with findability of the findee device by the finder device, and the determining, based on the privacy indication, whether to send to the finder device, ranging signaling based on the determination that the second token matches the first token includes:
determining, based on the privacy indication, to send to the finder device, ranging signaling based on the determination that the second token matches the first token; and
sending to the finder device, ranging signaling based on the determination that the second token matches the first token.

13. The findee device of claim 6, wherein the storing the first token comprises:
storing the first token on a memory in a communication chip.

14. The findee device of claim 6, wherein the operations further comprises:
receiving, from a server, a synchronization trigger message;
obtaining, based on the synchronization trigger message and the information in the registration message, a third token associated with the findee device and the finder device; and
replacing the first token with the third token.

15. The findee device of claim 6, wherein the operations further comprises:
determining, by the findee device a condition; and
disabling being the findee device based on the condition.

16. A computer-readable medium storing a plurality of instructions that, when executed by one or more processors of a computing device, cause the one or more processors to perform operations of a method implemented by a server, the method comprising:
receiving, from a findee device, a registration message indicating the findee device is to share future location data with a finder device;
obtaining a base date associated with a time the registration message was received by the server; and
sending the base date to the findee device.

17. The computer-readable medium of claim 16, wherein the method further comprises:
providing a secure channel for message exchanges between the finder device and the findee device.

18. The computer-readable medium of claim 16, wherein the method further comprises:
receiving, from the finder device, a finding request for finding the findee device; and
sending, to the findee device, a notification based on the finding request.

19. The computer-readable medium of claim 16, wherein the method further comprises:
maintaining a synchronization schedule; and
sending a synchronization trigger to the findee device or the finder device based on the synchronization schedule.

20. The computer-readable medium of claim 16, wherein the method further comprises:
receiving, from the findee device, a cancelation message indicating that the findee device is not to share future location data with the finder device.
